(19) United States
(12) Patent Application Publication
(10) Pub. No.: US 2023/0384108 A1
(43) Pub. Date: Nov. 30, 2023

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventor: Shinichiro HAMADA, Osaka (JP)

(73) Assignee: Panasonic Intellectual Property Corporation of America, Torrance, CA (US)

(21) Appl. No.: 18/231,330

(22) Filed: Aug. 8, 2023

Related U.S. Application Data
(63) Continuation of application No. PCT/JP2021/041413, filed on Nov. 10, 2021.

(30) Foreign Application Priority Data
Feb. 15, 2021 (JP) 2021-021901

(51) Int. Cl. G01C 21/34

(52) U.S. Cl. CPC G01C 21/3484

(57) ABSTRACT

A server acquires, from an achieved record database, achieved route information associating a start point, a finish point, and an achieved route being a past travel route between the start point and the finish point with one another, acquires a query including a start point and a finish point, creates one or more recommendable routes each having a start point and a finish point respectively agreeing with the start point and the finish point of the query by connecting one or more achieved routes recorded in the achieved data group, and outputs the one or more recommendable routes.

### FIELD OF INVENTION

This disclosure relates to a technology of creating a route.

### BACKGROUND ART

Researches and developments have been advanced concerning car navigation systems for taxis and personal vehicles, route guidance applications for pedestrians, and delivery schedule creation applications in transportation and delivery services. These technologies involve operability of determining an optimal travel route between two points. Each of Non-patent Literature 1 and Patent Literature 1 discloses a technology of determining such an optimal travel route between two points.

Non-patent Literature 1 discloses a technology related to the Dijkstra's algorithm for determining, based on topology data of a map, a travel route having a shortest time or a shortest distance between two points as an optimal travel route.

Patent Literature 1 discloses a technology of creating a road learning model of leaning a travel history of a road actually adopted by a skilled driver to travel thereon and determining an optimal travel route between two points by using the created road learning model to decrease a road cost of the road frequently adopted by the skilled driver.

However, each of the conventional technologies is directed to creation of a travel route resulting from a combination of local-area scored roads, and thus there is a possibility of calculating a travel route failing to reflect preference of a person and further having poor road connection.
Patent Literature 1: Japanese Unexamined Patent Publication No. 2019-82755
Non-Patent Literature 1: E. W. Dijkstra (1959). “A Note on Two Problems in Connexion with Graphs”, Numerische Mathematik, vol. 1, PP. 269-271

### SUMMARY OF THE INVENTION

This disclosure has been achieved to solve the drawbacks described above, and has an object of providing a technology of creating a travel route having good road connection while reflecting preference of a person.

An information processing method according to one aspect of this disclosure relates to an information processing method for creating a route, by a computer, including: acquiring an achieved data group having recordation of achieved route information associating a start point, a finish point, and an achieved route being a past travel route between the start point and the finish point with one another; acquiring a query including a start point and a finish point; creating one or more recommendable routes each having a start point and a finish point respectively agreeing with the start point and the finish point of the query by connecting one or more achieved routes recorded in the achieved data group; and outputting the one or more recommendable routes.

This disclosure achieves creation of a travel route having good road connection while reflecting preference of a person.

### BRIEF DESCRIPTION OF THE DRAWINGS

FIG. 1 shows an example of an overall configuration of an information processing system in a first embodiment of the disclosure.

FIG. 2 is a block diagram showing an example of a configuration of a server in the first embodiment of the disclosure.

FIG. 3 is a block diagram showing an example of a configuration of a manager terminal in the first embodiment of the disclosure.

FIG. 4 is a block diagram showing an example of a configuration of a driver terminal in the first embodiment of the disclosure.

FIG. 5 shows an example of a data configuration of an achieved record database in the first embodiment of the disclosure.

FIG. 6 is a flowchart showing an example of a process by the server in the first embodiment of the disclosure.

FIG. 7 is a block diagram showing an example of a configuration of a server in a second embodiment of the disclosure.

FIG. 8 is a flowchart showing an example of a process by the server in the second embodiment of the disclosure.

FIG. 9 is a block diagram showing an example of a data configuration of an achieved record database in the second embodiment of the disclosure.

FIG. 10 shows a display screen image of a first example in the second embodiment of the disclosure.

FIG. 11 shows a display screen image of a second example in the second embodiment of the disclosure.

FIG. 12 is a block diagram showing an example of a configuration of a server in a third embodiment of the disclosure.

FIG. 13 is a flowchart showing an example of a process by the server in the third embodiment of the disclosure.

FIG. 14 shows a display screen image of a first example in the third embodiment of the disclosure.

FIG. 15 shows a display screen image of a second example in the third embodiment of the disclosure.

### DETAILED DESCRIPTION

Circumstances LED Up to this Disclosure

An approach of determining a travel route having a shortest time or a shortest distance between two points have been widely employed to create an optimal travel route between the two points (e.g., Non-patent Literature 1). The approach is here called a mathematical optimization solver.

However, the travel route created by using the mathematical optimization solver frequently gives discomfort to a using person of an application. This is because a person sometimes thinks that a route which is not shortest is preferable for some reasons. For instance, a person does not always make a rational decision. Moreover, a person may determine a travel route from the viewpoints of easy travelability, safety, memorability, turnability at intersections, other than the viewpoints of a time and a distance. In this respect, a travel route created by using the mathematical optimization solver is considered to give discomfort to the person. Thus, the mathematical optimization solver has a defect of no reflection of preference of a person in selection of a travel route.

Patent Literature 1 discloses another way to overcome the defect of the mathematical optimization solver. Hereinafter, the way disclosed in Patent Literature 1 is called a route following solver. The route following solver adopts a road learning model of inputting characteristics (road distance information, road left turn information, road width information, and other information) about each road, and outputting a road cost for the road. Here, the road cost is leaned from a travel history and has a lower value as a road is adopted more frequently by a skilled driver or drivers to travel thereon. Further, according to the route following solver, a travel route between two points is calculated by combining roads resulting in having the lowest road cost.

As described above, the route following solver merely employs calculation of a travel route between two points by combining local-area scored roads, and thus fails to consider connection relation between roads and preference for a travel route resulting from the road combination. From this perspective, the route following solver has a possibility of calculating a travel route failing to reflect preference of a person and having poor road connection.

For instance, it is known that a person has tendency to prefer a linear route having fewer right and left turns to the shortest travel route having more small right and left turns. In this respect, the route following solver cannot cover this tendency.

This disclosure has been achieved to solve the drawbacks described above, and has an object of providing a technology of creating a travel route having good road connection while reflecting preference of a person.

An information processing method according to one aspect of this disclosure relates to an information processing method for creating a route, by a computer, including: acquiring an achieved data group having recordation of achieved route information associating a start point, a finish point, and an achieved route being a past travel route between the start point and the finish point with one another; acquiring a query including a start point and a finish point; creating one or more recommendable routes each having a start point and a finish point respectively agreeing with the start point and the finish point of the query by connecting one or more achieved routes recorded in the achieved data group; and outputting the one or more recommendable routes.

According to this configuration, a recommendable route is created by combining achieved routes actually selected by a person or people instead of combining local-area scored roads. This achieves creation of a travel route having good road connection while reflecting preference of each person.

In the information processing method, the achieved route information may further associate a travel specificity, and, in the output of the one or more recommendable routes, display data for a display screen image may be output to display the one or more achieved routes forming each recommendable route in association with the travel specificity.

This configuration displays each achieved route forming each recommendable route in association with the travel specificity, and thus can provide a using person with a judgment material for selecting a recommendable route.

In the information processing method, the travel specificity may include at least one of an experienced person who has used the one or more achieved routes forming the recommendable route, and a used date and time of the experienced person.

This configuration displays at least one of the experienced person who has used each achieved route forming each recommendable route, and a used date and time of the experienced person, and therefore succeeds in satisfying the using person with the recommendable route. For instance, when a specific person been displayed is reliable, the using person is satisfied that an achieved route associated with the specific person is a travel route having good road connection. Besides, for example, the using person is satisfied that no traffic congestion occurs in a time period around the used date and time being displayed, and thus the traffic condition is good.

The information processing method may further include determining, based on the achieved data group, an experienced person or people who are in a top n-th use frequency of the one or more achieved routes forming the recommendable route, where n is an integer equal to or greater than 1, and a used date and time of each experienced person. The display screen image may display the experienced person or people in the determined top n-th frequency and the used date and time of each experienced person in association with the one or more achieved routes forming the recommendable route.

According to this configuration, an experienced person or people who are in the top n-th use frequency of each achieved route forming each recommendable route are displayed. For instance, the more reliable people are included in people being displayed, the more satisfied is the using person that each achieved route associated with the reliable people is a travel route having good road connection. Moreover, the used date and time of each experienced person is displayed as well, and hence, the using person is further satisfied that the traffic condition at a time around the used date and time is good.

In the information processing method, the display screen image may include a map image on which the one or more achieved routes forming the recommendable route are displayed in a superimposed manner but distinctively.

This configuration displays the one or more achieved routes in a superimposed manner but distinctively, and thus allows the using person to grasp which section on the map corresponds to each achieved route.

In the information processing method, the display screen image may include a list image distinctively showing the one or more achieved routes forming the recommendable route in a list form.

This configuration displays the one or more achieved routes in the list form, and thus allows the using person to easily grasp each achieved route.

In the information processing method, in the output of the one or more recommendable routes, in a case where the one or more recommendable routes include a plurality of recommendable routes, the recommendable routes may be classified into a plurality of groups each including the same content, the number of recommendable routes constituting each of the groups may be determined, and a recommendable route or routes of groups until a top m-th group in the determined number, where m is an integer equal to or greater than 1, may be output.

According to this configuration, in the case where one or more recommendable routes include a plurality of recommendable routes, the recommendable routes are classified into a plurality of groups in accordance with the content of each recommendable route, and a recommendable route or routes of groups until the top m-th group in the number of recommendable routes constituting each of the group are output. This configuration therefore enables presentation of various recommendable routes before a using person.

The information processing method may further include: acquiring selection information indicating a certain recommendable route selected by an using person among the one or more recommendable routes; and recording, in the acquisition of the achieved data group, an achieved route forming the certain recommendable route in the achieved data group.

This configuration achieves reflection of a selection result of the recommendable route by the using person in the achieved data group. Accordingly, the recommendable route selected by the using person is available as an achieved route to create a new recommendable route.

In the information processing method, the achieved route may include a plurality of roads.

According to this configuration, the achieved route includes the plurality of roads, and hence, each achieved route can include wide-area roads in place of local-area roads.

In the information processing method, in the creation of the one or more recommendable routes, the one or more recommendable routes may be created by increasing the connection number one by one, and the process may be finished at completion of forming the one or more recommendable routes.

In this configuration, a recommendable route having a smaller connection number is preferentially created. This results in attaining a shortened process time and a reduced process load.

An information processing device according to another aspect of this disclosure creates a route. The information processing device includes: an achieved record acquisition part that acquires an achieved data group having recordation of achieved route information associating a start point, a finish point, and an achieved route being a travel route between the start point and the finish point with one another; a query acquisition part that acquires a query including a start point and a finish point; a creation part that creates one or more recommendable routes each having a start point and a finish point respectively agreeing with the start point and the finish point of the query by connecting one or more achieved routes recorded in the achieved data group; and an output part that outputs the one or more recommendable routes.

With this configuration, it is possible to provide an information processing device that exerts the same operational effects as those of the information processing method described above.

A program according to further another aspect of this disclosure causes a computer to serve as an information processing device that creates a route. The program further causes the computer to serve as: an achieved record acquisition part that acquires an achieved data group having recordation of achieved route information associating a start point, a finish point, and an achieved route being a travel route between the start point and the finish point with one another; a query acquisition part that acquires a query including a start point and a finish point; a creation part that creates one or more recommendable routes each having a start point and a finish point respectively agreeing with the start point and the finish point of the query by connecting one or more achieved routes recorded in the achieved data group; and an output part that outputs the one or more recommendable routes.

With this configuration, it is possible to provide a program that exerts the same operational effects as those of the information processing method described above.

This disclosure can be realized as an information processing system caused to operate by the program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

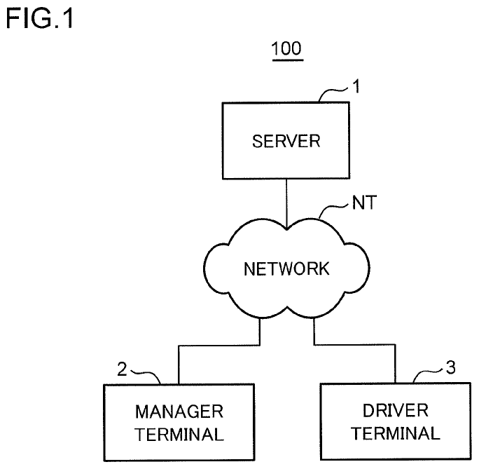

FIG. 1 shows an example of an overall configuration of an information processing system 100 in a first embodiment of the disclosure. The information processing system 100 creates a travel route for an article delivery vehicle in a transport company. However, this is a mere example. The information processing system 100 may create a travel route for vehicles, such as busses or taxis, in a transportation company, or may create a travel route for a vehicle in response to a general user. Such a travel route created by the information processing system 100 is not limited to the one for the vehicle, but may be the one for users. The vehicle is not limited to an automobile, but may include a bicycle.

The information processing system 100 includes a server 1 (which is an example of the information processing device), a manager terminal 2, and a driver terminal 3. The server 1, the manager terminal 2, and the driver terminal 3 are communicably connected to one another via a network NT. The network NT includes, for example, a wide area network having an internet communication network and a mobile phone communication network.

The server 1 includes a cloud server including one or more computers. The server 1 receives a query from the manager terminal 2. The query represents a retrieval request for a travel route from a start point to a finish point. The server 1 creates a recommendable route being a travel route in response to the query, and transmits to the manager terminal 2 display data for a display screen image to display the recommendable route. The server 1 may receive the query from the driver terminal 3 and create the recommendable route in response to the query. In the description below, the query is defined to be transmitted from the manager terminal 2.

The manager terminal 2 is used by, for example, a manager who manages vehicle distribution at a collection and delivery station in the transport company. The manager terminal 2 may include, for example, a stationary computer, or a mobile terminal, such as a smartphone or a tablet computer.

The driver terminal 3 may include an on-vehicle terminal to be mounted on a vehicle, or a mobile terminal owned by a driver of the vehicle. The mobile terminal includes, for example, a smartphone or a tablet computer.

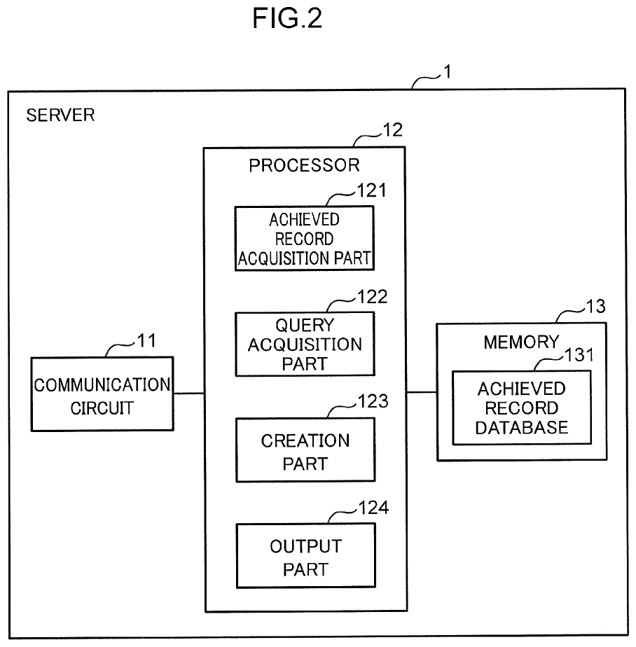

FIG. 2 is a block diagram showing an example of a configuration of the server 1 in the first embodiment of the disclosure. The server 1 includes a communication circuit 11, a processor 12, and a memory 13. The communication circuit 11 connects the server 1 to the network NT.

The communication circuit 11 receives a query transmitted from the manager terminal 2. The communication circuit 11 transmits, to the manager terminal 2, display data for the display screen image to display a recommendable route in response to the query. The communication circuit 11 may transmit the display data to the driver terminal 3. The communication circuit 11 further receives a travel route created by the manager. The communication circuit 11 further receives a travel history of the driver.

The processor 12 includes an electric circuit, such as, a CPU (Central Processing Unit), or an FPGA (Field Programmable Gate Array). The processor 12 includes an achieved record acquisition part 121, a query acquisition part 122, a creation part 123, and an output part 124.

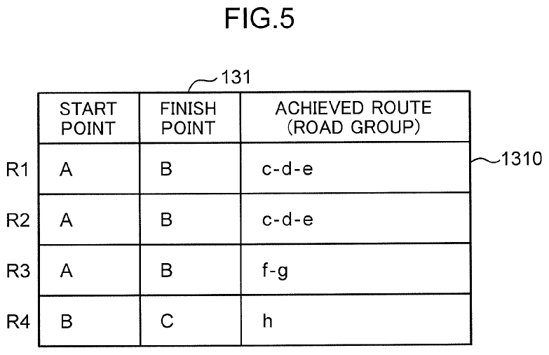

The achieved record acquisition part 121 acquires achieved route information from an achieved record database 131. The acquired achieved route information corresponds to an example of an achieved data group. FIG. 5 shows an example of a data configuration of the achieved record database 131 in the first embodiment of the disclosure. The achieved record database 131 records one or more pieces of achieved route information 1310. The achieved route information 1310 includes information associating a start point, a finish point, and an achieved route being a travel route between the start point and the finish point with one another.

The achieved route is a travel route created by the manager or adopted by the driver by trial and error from experiences and knowledge to meet a given delivery schedule. For instance, the manager creates a delivery route, based on a delivery schedule associating a destination with an article to be delivered to the destination, for effective article delivery at a plurality of destinations by each delivery vehicle. The driver also proposes a delivery route available for the effective article delivery, and travels a corresponding delivery vehicle along the delivery route. As the delivery route, a certain travel route from the collection and delivery station to a specific destination or another certain travel route between specific delivery destinations establishes an achieved route. The start point of the achieved route corresponds to the collection and delivery station or the delivery destination, and the finish point of the achieved route corresponds to the delivery destination or the collection and delivery station.

As described above, the achieved route information 1310 includes a travel route created by the manager or the driver from experiences and knowledge thereof. It is said that the achieved record database 131 includes an achieved data group full of know-how of the manager or the driver. The server 1 executes creation of a recommendable route, which will be described below, after a predetermined number of or more pieces of the achieved route information 1310 are stored in the achieved record database 131.

In the example in FIG. 5, an achieved route R1 indicated by the achieved route information 1310 in the first row includes a road group having roads “c”, “d”, and “e” connecting a start point “A” and a finish point “B” to each other. Each of signs “c”, “d” and other signs represents a road ID (identifier) uniquely identifying the corresponding road. An achieved route R2 indicated by the achieved route information 1310 in the second row has the same content as that of the achieved route R1 in the first row. The achieved record database 131 stores the achieved route information 1310 per achieved creation by the manager and achieved travel by the driver.

The example in FIG. 5 shows the achieved routes R1, R2, and R3 each connecting the start point “A” and the finish point “B” to each other. Among the routes, two cases of the achieved route “c-d-e” represented by the achieved routes R1, R2 are recorded, while only one case of the achieved route “f-g” represented by the achieved route R3 is recorded. It is seen from this perspective that the achieved route “c-d-e“is used more frequently than the archived route” f-g”, and thus is highly likely to be more suitable for preference of a person.

The query acquisition part 122 acquires a query including a start point and a finish point. The start point represents a start point of a travel route requested for retrieval by a using person and the finish point represents a finish point of the travel route requested for retrieval by the using person. For instance, each of the start point and the finish point of the query may adopt a predetermined point. Examples of the predetermined point include a start point and finish point, i.e., the collection and delivery station or a delivery destination, recorded in the achieved record database 131.

Examples of an available way of inputting the start point and the finish point of the query include a way of permitting the manager to select the start point and the finish point of the query from a plurality of predetermined points displayed in a list form on the manager terminal 2. Alternatively, another adoptable way of inputting the start point and the finish point of the query may include allowing the using person to designate a specific position on a map image displayed on the manager terminal 2 and determining, based on the designated position, the start point and the finish point of the query. In this case, the query acquisition part 122 may calculate a Euclidean distance between the designated position and each predetermined point, and determine the point where the calculated Euclidean distance is shortest and has a value equal to or smaller than a threshold as the start point or the finish point of the query.

The creation part 123 creates one or more recommendable routes each having a start point and a finish point respectively agreeing with the start point and the finish point of the query by connecting one or more achieved routes recorded in the achieved record database 131. Here, the creation part 123 creates the one or more recommendable routes by increasing the connection number one by one, and the addition is finished at completion of forming the one or more recommendable routes.

The output part 124 outputs the one or more recommendable routes by transmitting the display data for a display screen image to the manager terminal 2 and the driver terminal 3 via the communication circuit 11 to display the one or more recommendable routes created by the creation part 123. In a case where the one or more recommendable routes created by the creation part 123 include a plurality of recommendable routes, the output part 124 may classify the recommendable routes into a plurality of groups each including the same content, determine the number of recommendable routes constituting each of the groups, and output a recommendable route or routes of a top first group or groups in the largest number.

The memory 13 includes a non-volatile storage device, such as an HDD (Hard Disk Drive) and an SSD (solid state drive). The memory 13 stores the achieved record database 131.

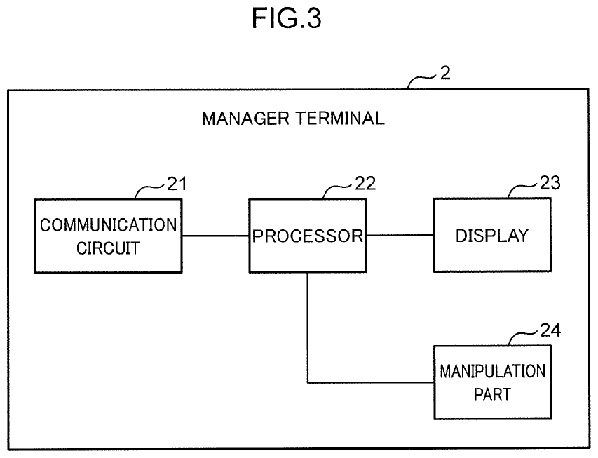

FIG. 3 is a block diagram showing an example of a configuration of the manager terminal 2 in the first embodiment of the disclosure. The manager terminal 2 includes a communication circuit 21, a processor 22, a display 23, and a manipulation part 24. The communication circuit 21 includes an electric circuit connecting the manager terminal 2 to the network NT. The communication circuit 21 transmits a query to the server 1. The communication circuit 21 receives display data for a display screen image to display a recommendable route transmitted from the server 1.

The processor 22 includes an electric circuit, such as a CPU, and controls the entirety of the manager terminal 2. For instance, the processor 22 creates the display screen image based on the display data received by the communication circuit 21 and causes the display 23 to display the display screen image. When the manipulation part 24 receives a manipulation of inputting the query from the using person, the processor 22 causes the server 1 to transmit the query via the communication circuit 21.

The display 23 includes a display device, such as a liquid crystal display and an organic EL display. The manipulation part 24 includes a manipulation device having a keyboard and a mouse. The manipulation part 24 receives the manipulation of inputting of the query from the using person. When the manager terminal 2 includes a mobile terminal, the manipulation part 24 may include a touch screen.

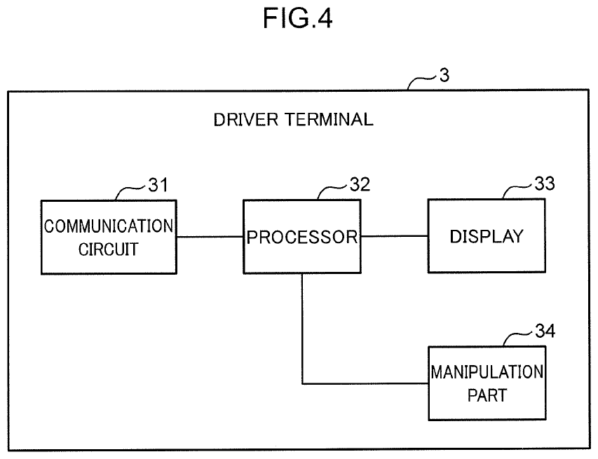

FIG. 4 is a block diagram showing an example of a configuration of the driver terminal 3 in the first embodiment of the disclosure. The driver terminal 3 includes a communication circuit 31, a processor 32, a display 33, and a manipulation part 34.

The communication circuit 31 includes an electric circuit connecting the driver terminal 3 to the network NT. The communication circuit 31 receives display data for a display screen image to display a recommendable route transmitted from the server 1. The processor 32 includes, for example, an electric circuit, such as a CPU, and controls the entirety of the driver terminal 3. For instance, the processor 32 creates a display screen image based on the display data received by the communication circuit 31 and causes the display 33 to display the display screen image.

The display 33 includes a display device, such as a liquid crystal display and an organic EL display. The manipulation part 24 includes a manipulation device having a manipulation button and a touch screen.

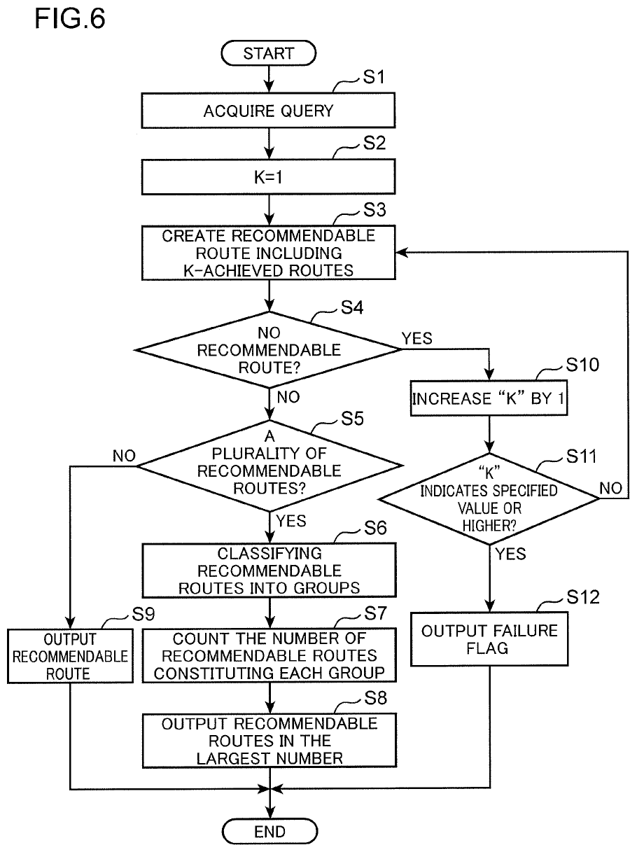

FIG. 6 is a flowchart showing an example of a process by the server 1 in the first embodiment of the disclosure. It is noted that the achieved record database 131 stores a predetermined number of or more pieces of achieved route information 1310 prior to execution of the process in the flowchart.

In step S1, the query acquisition part 122 acquires a query transmitted from the manager terminal 2.

In step S2, the creation part 123 sets a variable “K” representing the connection number of achieved routes to 1 as an initial value.

In step S3, the creation part 123 retrieves K-achieved routes that are connectable from the achieved record database 131 so that a start point and a finish point of each achieved route agrees with a start point and a finish point of the query acquired in step S1, and creates one or more recommendable routes based on a retrieval result. In this manner, the creation part 123 creates the one or more recommendable routes each formed by the K-achieved routes.

In a case where the query has a start point “A” and a finish point “C” and K=2, the following three recommendable routes are retrieved from the achieved record database 131 in the example shown in FIG. 5:

Achieved route R1+Achieved route R4 “A-c-d-e-B-h-C”; Achieved route R2+Achieved route R4 “A-c-d-e-B-h-C”; and Achieved route R3+Achieved route R4 “A-f-g-B-h-C”.

The sign “+” represents connection of achieved routes. The route “A-c-d-e-B-h-C” indicates a travel route starting from the start point “A”, passing through the road “c”, the road “d”, the road “e”, the point “B, and the road “h”, and reaching the finish point “C”. The travel route obtained in this manner results in a recommendable route. The achieved route R1 and the achieved route R2 have the same content, but respectively have independent connection. This is aimed at counting the number of cases for use in determining a recommendable route or routes to be finally output.

In step S4, the creation part 123 determines whether the number of recommendable routes created in step S3 indicates “0”, i.e., determines whether no recommendable route is created in step S3. For instance, when K=1 in the example in FIG. 5, there is no achieved route directly connecting the start point “A” and the finish point “C” to each other, thus the number of recommendable routes indicates “0”. Contrarily, when the number of recommendable routes is other than “0” (NO in step S4), the process proceeds to step S5.

In step S5, the output part 124 determines whether a plurality of recommendable routes is created in step S4. When it is determined that one recommendable route is created (NO in step S5), the output part 124 outputs the one recommendable route (step S9).

When it is determined that the plurality of recommendable routes is created (YES in step S5), the output part 124 classifies the recommendable routes into groups having the same achieved route or routes (step S6).

In step S7, the output part 124 counts the number of recommendable routes constituting each group. For instance, in the example described above, the number of recommendable routes constituting each group concerning the route “A-c-d-e-B-h-C” is counted as two and the number of recommendable routes constituting a group concerning the route “A-f-g-B-h-C” is counted as one.

In step S8, the output part 124 outputs a recommendable route or routes of a top first group or groups in the largest number of the recommendable routes among the groups. In the example described above, a recommendable route “A-c-d-e-B-h-C” is output. In this case, for example, the manager terminal 2 displays a display screen image showing the recommendable route “A-c-d-e-B-h-C” in response to the query thereon. In a case where there is a plurality of recommendable routes in the largest number, the output part 124 may output the recommendable routes in the largest number.

In step S4, when it is determined that the number of recommendable routes indicates “0” (YES in step S4), the creation part 123 increases the variable K by 1 (step S10).

In step S11, the creation part 123 determines whether the variable K indicates a specified value or higher. When the variable K indicates the specified value or higher (YES in step S11), the creation part 123 outputs a failure flag (step S12). In this case, for example, the manager terminal 2 displays an error massage showing a failure in retrieval of a recommendable route in response to the query.

In step S11, when the variable K is lower than the specified value (NO in step S11), the process returns to step S3. The specified value takes, for example, a value predetermined to prevent a failure in step S3. That is to say, the flowchart in FIG. 6 adopts an algorithm of increasing the variable K one by one, and finishing the process at completion of forming the recommendable route or routes. In this manner, a recommendable route having a smaller connection number is preferentially retrieved to attain a shortened process time and a reduced process load.

Conclusively, according to the first embodiment, a recommendable route is created by combining achieved routes actually selected by a person or people instead of combining local-area scored roads. This achieves creation of a travel route having good road connection while reflecting preference of each person.

### Second Embodiment

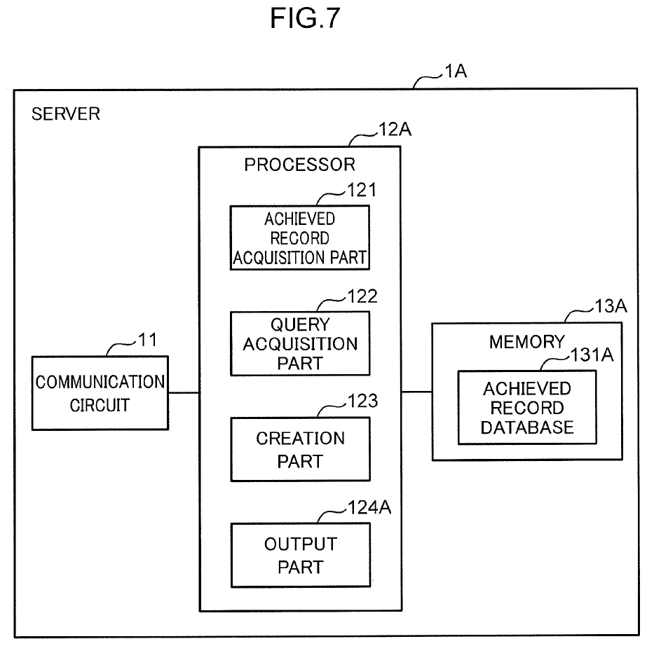

A second embodiment aims at associating an achieved route with a travel specificity in outputting a recommendable route. FIG. 7 is a block diagram showing an example of a configuration of a server 1A in the second embodiment of the disclosure. In the second embodiment, constituent elements which are the same as those in the first embodiment are given the same reference numerals and signs, and thus explanation therefor will be omitted.

A processor 12A included in the server 1A includes an achieved record acquisition part 121, a query acquisition part 122, a creation part 123, and an output part 124A.

The output part 124A outputs display data for a display screen image to display each achieved route forming each recommendable route created by the creation part 123 and a travel specificity in association with each other. The travel specificity includes at least one of an experienced person who has used each achieved route forming each recommendable route, and a used date and time of the experienced person. Here, the travel specificity will be explained to include the experienced person and the relevant used date and time.

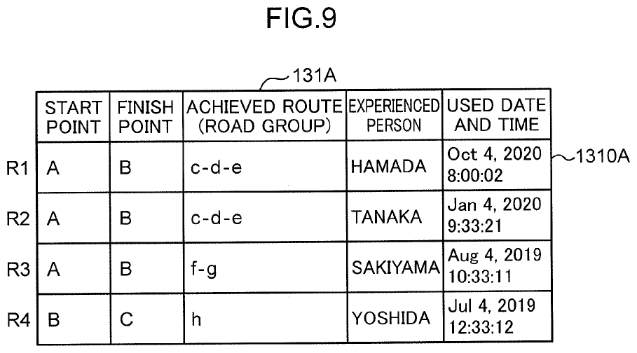

The memory 13A has an achieved record database 131A. FIG. 9 shows an example of a data configuration of the achieved record database 131A in the second embodiment of the disclosure. Achieved route information 1310A further associates an experienced person, and a used date and time with a start point, a finish point, and an achieved route.

For instance, an achieved route R1 having the recordation of “Hamada” as the experienced person and a used date and time “08:00:02 on Oct. 4, 2020” as the used date and time shows that the route was used by a driver called Hamada at 08:00:02 on Oct. 4, 2020. An achieved route R2 has the same constituent road group as the achieved route R1 except that an experienced person therefor indicates “Tanaka” and a used date and time indicates “09:33:21 on Jan. 4, 2019”.

The display screen image may include a map image on which each achieved route forming each recommendable route is displayed in a superimposed manner but distinctively, or include a list image on which each achieved route forming each recommendable route may be distinctively shown in a list form.

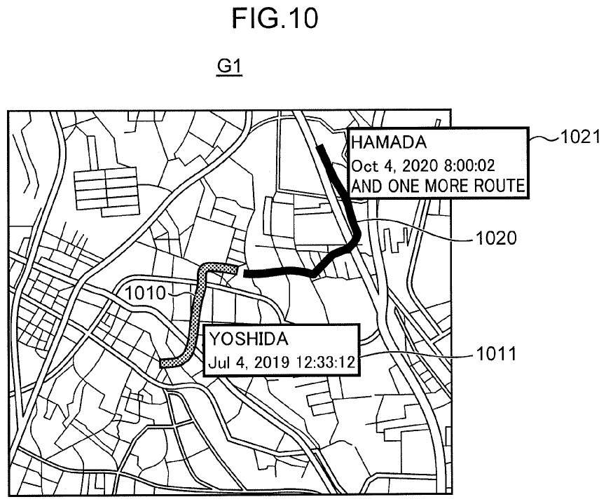

FIG. 10 shows a display screen image G1 of a first example in the second embodiment of the disclosure. The display screen image G1 shows a recommendable route including an achieved route 1010 and an achieved route 1020 on the map in a superimposed manner. The display screen image G1 shows the achieved route 1010 and the achieved route 1020 in different colors from each other. Accordingly, the using person can easily grasp a section of each achieved route forming a recommendable route.

The achieved route 1010 is displayed in association with a travel specificity display frame 1011. The achieved route 1020 is displayed in association with a travel specificity display frame 1021.

Each of the travel specificity display frame 1011 and the travel specificity display frame 1021 shows an experienced person and a used date and time as recorded in the achieved record database 131A. The travel specificity display frame 1011 shows use of the achieved route 1010 by Yoshida at 12:33:12 on Jul. 4, 2019. The travel specificity display frame 1021 shows use of the achieved route 1020 by Hamada at 8:00:02 on Oct. 4, 2020.

Such displaying of the achieved route in association with the experienced person can make the using person satisfied that the achieved route is a travel route having good road connection, for example, when the experienced person is reliable. Moreover, further displaying of the used date and time for the achieved route can make the using person satisfied that the traffic condition at a time around the used date and time is good.

For instance, when the achieved record database 131A records a plurality of experienced people for the achieved route 1010 each as the experienced person, the output part 124A may display, in the travel specificity display frame 1011, an experienced person or people who are in the top first use frequency of the route. Moreover, when the achieved record database 131A records a plurality of used dates and times of each experienced person who is in the top first use frequency of the achieved route 1010, the output part 124A may display, in the travel specificity display frame 1011, a representative used date and time among the used dates and times.

The travel specificity display frame 1021 further shows the term “AND ONE MORE ROUTE”. This means that, in addition to the achieved route 1020, another achieved route having the same start point and the finish point as those of the achieved route 1020 exists. This is a mere example, another term “AND ONE MORE PERSON” may be displayed in place of the term “AND ONE MORE ROUTE”. This term “AND ONE MORE PERSON” means that the achieved route 1020 has been used by another experienced person in addition to “Hamada”. This permits the using person to understand the popularity of the achieved route 1020.

The representative used date and time may be, for example, the latest used date and time or an average used date and time of a plurality of used dates and times. Alternatively, the representative used date and time may indicate a time period showing the highest use frequency.

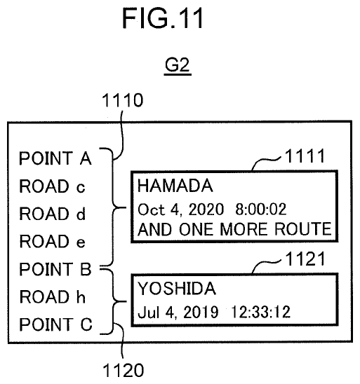

FIG. 11 shows a display screen image G2 of a second example in the second embodiment of the disclosure. The display screen image G2 includes a list image showing an achieved route 1110 and an achieved route 1120 in a list form.

The achieved route 1110 is a travel route starting from the point “A”, passing through the road “c”, the road “d”, and the road “e”, and reaching the point “B”. The achieved route 1120 is a travel route starting from the point “B”, passing through the road “h”, and reaching the point “C”. The point “A” represents a start point of a recommendable route and the point “C” represents a finish point of the recommendable route.

The achieved route 1110 is displayed in association with a travel specificity display frame 1111. The achieved route 1120 is displayed in association with a travel specificity display frame 1121.

The content of the travel specificity display frame 1111 is the same as that of the travel specificity display frame 1021, and the content of the travel specificity display frame 1121 is the same as that of the travel specificity display frame 1011.

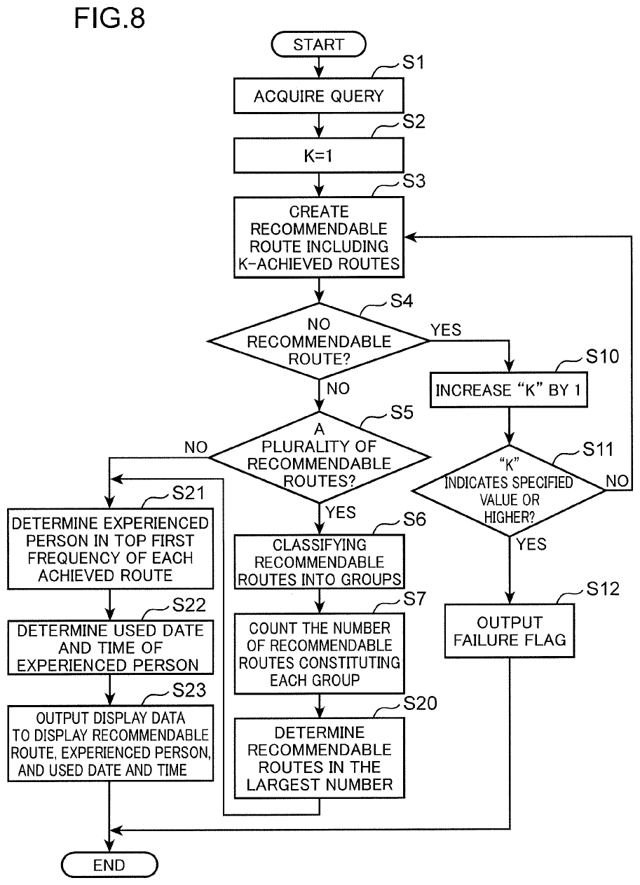

FIG. 8 is a flowchart showing an example of a process by the server 1A in the second embodiment of the disclosure. In FIG. 8, steps which are the same as those in FIG. 6 are given the same reference numerals and signs, and thus explanation therefor will be omitted. FIG. 8 omits steps S8 and S9 shown in FIG. 6. Moreover, when it is determined “NO” in step S5, the process proceeds to step S21.

In step S20 subsequent to step S7, the output part 124A determines a recommendable route or routes of a group or groups having the largest number of recommendable routes among the groups.

In step S21, the output part 124A determines, with reference to the achieved record database 131A, an experienced person or people who are in the top first use frequency of each achieved route forming one recommendable route to be output.

In step S22, the output part 124A determines a used date and time of each experienced person who is in the top first use frequency of the achieved route. When the achieved record database 131A records a plurality of used dates and times of each experienced person who is in the top first frequency of the achieved route, the output part 124A may determine a representative used date and time among the used dates and times.

In step S23, the output part 124A outputs display data for a display screen image to display a certain recommendable route to be output, an experienced person and a used date and time for the achieved route forming the certain recommendable route. The display data here is transmitted to the manager terminal 2 and the driver terminal 3. Each of the manager terminal 2 and the driver terminal 3 displays a display screen image based on the received display data. Specifically, each of the manager terminal 2 and the driver terminal 3 displays the display screen image G1 or the display screen image G2.

Conclusively, the second embodiment aims at displaying an achieved route in association with a travel specificity, and thus can provide a using person with a judgment material for selecting a recommendable route.

### Third Embodiment

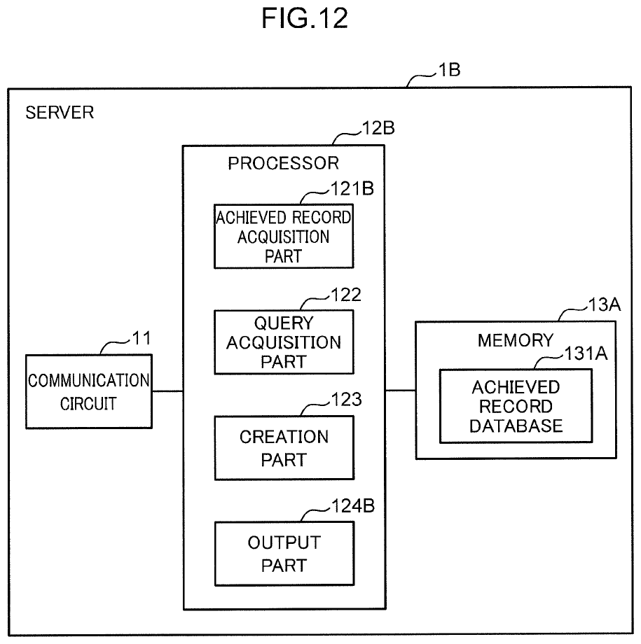

A third embodiment aims at, in a case of creating a plurality of recommendable routes, outputting a recommendable route or routes in a top m-th largest number. FIG. 12 is a block diagram showing an example of a configuration of a server 1B in the third embodiment of the disclosure. In the third embodiment, constituent elements which are the same as those in the first and second embodiments are given the same reference numerals and signs, and thus explanation therefor will be omitted.

A processor 12B included in the server 1B includes an achieved record acquisition part 121B, a query acquisition part 122, a creation part 123, and an output part 124B. The achieved record acquisition part 121B acquires selection information indicating one recommendable route selected from the output recommendable routes by a using person. The selection information is transmitted from a manager terminal 2 or a driver terminal 3 and received by a communication circuit 11. The achieved record acquisition part 121B records an achieved route forming the one recommendable route indicated by the selection information in the achieved record database 131A.

In a case where a plurality of recommendable routes is created by the creation part 123, the output part 124B classifies the recommendable routes into a plurality of groups each including the same content, determines the number of recommendable routes constituting each of the groups, and outputs a recommendable route or routes of groups until a top m-th group in the determined number, where m is an integer equal to or greater than 2.

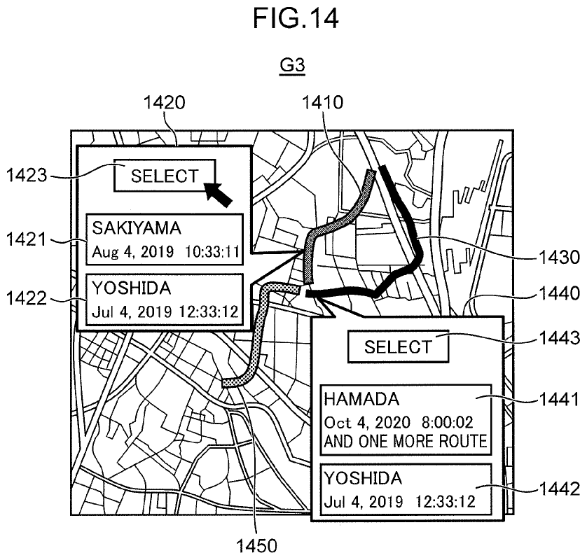

FIG. 14 shows a display screen image G3 of a first example in the third embodiment of the disclosure. The display screen image G3 shows two recommendable routes of a first recommendable route and a second recommendable route on a map in a superimposed manner, the first recommendable route including an achieved route 1410 and an achieved route 1450, and the second recommendable route including an achieved route 1430 and an achieved route 1450. The display screen image G3 further shows the achieved route 1410, the achieved route 1430, and the achieved route 1450 in different colors from one other.

The achieved route 1410 is displayed in association with a first display frame unit 1420. The achieved route 1430 is displayed in association with a second display frame unit 1440. The first display frame unit 1420 shows a travel specificity for the first recommendable route. The second display frame unit 1440 shows a travel specificity for the second recommendable route.

The first display frame unit 1420 includes a travel specificity display frame 1421, a travel specificity display frame 1422, and a selection button 1423. The travel specificity display frame 1421 shows an experienced person and a used date and time of the experienced person for the achieved route 1410. The travel specificity display frame 1422 shows an experienced person and a used date and time of the experienced person for the achieved route 1450.

The travel specificity display frame 1421 shows the content about use of the achieved route 1410 by Sakiyama at 10:33:11 on Aug. 4, 2019. The reason why the travel specificity display frame 1421 shows Sakiyama as an experienced person lies in that the use frequency of the achieved route 1450 as registered in the achieved record database 131A indicates the top first. It is noted here that the used date and time displayed in the travel specificity display frame 1421 indicates a representative used date and time among the used dates and times of the experienced person who is in the top first frequency in the same manner as the second embodiment. These features are seen in the travel specificity display frame 1422, a travel specificity display frame 1441, and a travel specificity display frame 1442 as well.

The travel specificity display frame 1422 shows the content about use of the achieved route 1450 by Yoshida at 12:33:12 on Jul. 4, 2019.

The selection button 1423 receives a manipulation to select the first recommendable route by the using person. When the selection button 1423 is selected, selection information indicating the selection of the first recommendable route is transmitted from the manager terminal 2 or the driver terminal 3 to a server 1. Further, when the selection button 1423 is selected, the driver terminal 3 may start navigation of the first recommendable route.

The second display frame unit 1440 includes the travel specificity display frame 1441, the travel specificity display frame 1442, and a selection button 1443. The travel specificity display frame 1441 shows an experienced person and a used date and time of the experienced person for the achieved route 1430. The travel specificity display frame 1441 shows the content about use of the achieved route 1430 by Hamada at 08:00:02 on Oct. 4, 2020.

The travel specificity display frame 1442 shows an experienced person and a used date and time of the experienced person for the achieved route 1450. Here, the travel specificity display frame 1442 shows a travel specificity of the achieved route 1450 in the same manner as the travel specificity display frame 1422, and thus has the same content as that of the travel specificity display frame 1422.

The selection button 1443 receives a manipulation to select the second recommendable route by the using person. When the selection button 1443 is selected, selection information indicating the selection of the second recommendable route is transmitted from the manager terminal 2 or the driver terminal 3 to the server 1. Further, when the selection button 1443 is selected, the driver terminal 3 may start navigation of the first recommendable route.

The reason why the two recommendable routes are displayed in FIG. 14 lies in that the output part 124B outputs the recommendable routes until the top second largest number among the plurality of recommendable routes. When a recommendable route or routes until the m-th largest number are output, the display screen image G3 shows the m-recommendable routes.

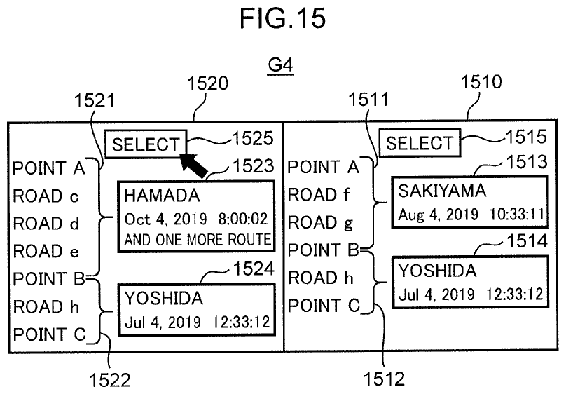

FIG. 15 shows a display screen image G4 of a second example in the third embodiment of the disclosure. The display screen image G4 includes a first list image 1510 and a second list image 1520. The first list image 1510 shows achieved routes forming a first recommendable route in a list form. The second list image 1520 shows achieved routes forming a second recommendable route in a list form.

The first list image 1510 includes an achieved route 1511, an achieved route 1512, a travel specificity display frame 1513, a travel specificity display frame 1514, and a selection button 1515.

The achieved route 1511 is a travel route starting from the point “A”, passing through the road “f” and the road “g”, and reaching the point “B”. The achieved route 1512 indicates a route starting from the point “B”, passing through the road “h”, and reaching the point “C”. The content of the travel specificity display frame 1513 is the same as that of the travel specificity display frame 1421 shown in FIG. 14, and the content of the travel specificity display frame 1514 is the same as that of the travel specificity display frame 1422 shown in FIG. 14.

The selection button 1515 is equivalent to the selection button 1423 shown in FIG. 14.

The second list image 1520 includes an achieved route 1521, an achieved route 1522, a travel specificity display frame 1523, a travel specificity display frame 1524, and a selection button 1525. The achieved route 1521 is the same as the achieved route 1110 shown in FIG. 11 and the achieved route 1522 is the same as the achieved route 1120 shown in FIG. 11. The content of the travel specificity display frame 1523 is the same as that of the travel specificity display frame 1441 shown in FIG. 14, and the content of the travel specificity display frame 1524 is the same as that of the travel specificity display frame 1442 shown in FIG. 14. The selection button 1525 is equivalent to the selection button 1443 shown in FIG. 14.

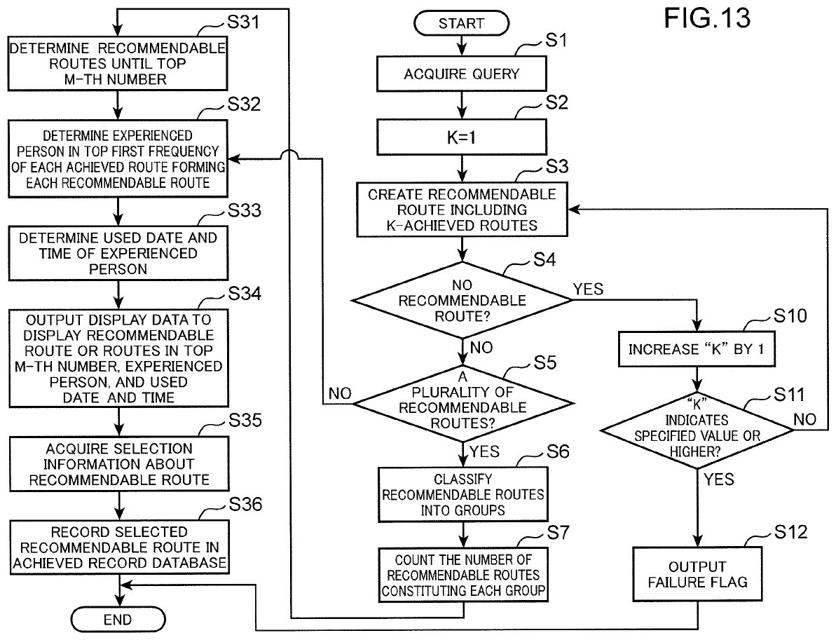

FIG. 13 is a flowchart showing an example of a process by the server 1B in the third embodiment of the disclosure. In the flowchart shown in FIG. 13, steps which are the same as those in FIG. 8 are given the same reference numerals and signs, and thus explanation therefor will be omitted. Moreover, in FIG. 13, when it is determined “NO” in step S5, the process proceeds to step S32.

In step S31 subsequent to step S7, the output part 124B determines a recommendable route or routes to be output until a top m-th group in the number of recommendable routes constituting each of the groups. For instance, it is presumed that obtained is a processing result in step S7 that the number of recommendable routes constituting each group concerning the route “A-c-d-e-B-h-C” is two and the number of recommendable routes constituting a group concerning the route “A-f-g-B-h-C” is one. Besides, it is defined that m=2. In this case, a recommendable route “A-c-d-e-B-h-C” and a recommendable route “A-f-g-B-h-C” until the top second group in the number are output.

In step S32, the output part 124B determines an experienced person who is in a top first frequency of each achieved route forming each recommendable route until the top m-th number in step S31.

In step S33, the output part 124B determines a used date and time of the experienced person who is in the top first frequency of each achieved route

In step 534, the output part 124B outputs display data for a display screen image to display a recommendable route or routes until the top m-th number to be output, and an experienced person and a used date and time for each achieved route forming each recommendable route.

Specifically, each of the manager terminal 2 and the driver terminal 3 displays the display screen image G3 or the display screen image G4.

In step 535, the achieved record acquisition part 121B acquires selection information indicating a certain recommendable route selected from the recommendable routes in the top m-th number by the using person. This selection is executed through a manipulation of selecting the selection button 1423 or the selection button 1443 on the display screen image G3, or selecting the selection button 1515 or the selection button 1525 on the display screen image G4.

In step S36, the achieved record acquisition part 121B records the certain recommendable route indicated by the selection information in the achieved record database 131A. For instance, when the certain recommendable route includes the achieved route R1 and the achieved route R4 shown in FIG. 5, the achieved record acquisition part 121B may divide the certain recommendable route into the achieved route R1 and the achieved route R4, and record the divided achieved route R1 and achieved route R4 in the achieved record database 131A. In this case, the achieved record acquisition part 121B may record a selected using person as an experienced person and record a selected date and time as the used date and time in the achieved record database 131A. Moreover, in this case, the manager terminal 2 or the driver terminal 3 may transmit, to the server 1, the selection information additionally including the name of the selected using person and the selected date and time.

Conclusively, according to this third embodiment, a recommendable route or routes until the m-the group in the number are output. This configuration therefore enables presentation of various recommendable routes to a using person. Furthermore, the achieved record database 131A reflects a selection result of the recommendable route by the using person. Accordingly, the recommendable route selected by the using person is available as an achieved route to create a new recommendable route.

This disclosure can adopt modifications described below.

First Modification

When it is determined “YES” in step S11 in FIG. 6, the creation part 123 may retrieve a recommendable route in response to a query by using a conventional route retrieving solver, such as the mathematical programming solver or the route following solver, instead of outputting a failure flag (step S12).

Second Modification

In a case where the achieved record database 131, 131A includes other achieved routes each having the same start point and finish point as those of each achieved route forming a recommendable route to be output, the output part 124 may select a specific achieved route from the other achieved routes, and output the selected achieved route. For example, the output part 124 may output an achieved route or routes until a top r-th number among the other achieved routes, where r indicates an integer equal to or greater than 1. In this case, the output part 124 may display a travel specificity in association with each selected achieved route.

Third Modification

The output part 124A determines the experienced person who is in the top first use frequency of each achieved route in step S21 in FIG. 8, but may determine an experienced person or people who are in the top n-th use frequency of each achieved route as an experienced person or people to be displayed, where n indicates integer equal to or greater than 2. Moreover, in this case, in step S22, a used date and time of each experienced person who is in the top n-th use frequency is determined as the used date and time. The determination is applicable to the flowchart shown in FIG. 13 as well.

Fourth Modification

The server 1 includes the blocks of the processor 12, but the disclosure is not limited thereto. The manager terminal 2 and the driver terminal 3 may include the blocks. Alternatively, the server 1 may include a part of the blocks of the processor 12, and the manager terminal 2 and the driver terminal 3 may include the remaining blocks. In these aspects, the achieved record database 131 may be included in the server 1, or included in each of the manager terminal and the driver terminal 3, or alternatively, may be included in another server different from the server 1.

This disclosure achieves creation of a travel route having good road connection while reflecting preference of a person, and thus is useful for a route retrieval application.

1. An information processing method for creating a route, by a computer, comprising:
acquiring an achieved data group having recordation of achieved route information associating a start point, a finish point, and an achieved route being a past travel route between the start point and the finish point with one another;
acquiring a query including a start point and a finish point;
creating one or more recommendable routes each having a start point and a finish point respectively agreeing with the start point and the finish point of the query by connecting one or more achieved routes recorded in the achieved data group; and
outputting the one or more recommendable routes.

2. The information processing method according to claim 1, wherein the achieved route information further associates a travel specificity, and,
in the output of the one or more recommendable routes, display data for a display screen image is output to display the one or more achieved routes forming each recommendable route in association with the travel specificity.

3. The information processing method according to claim 2, wherein the travel specificity includes at least one of an experienced person who has used the one or more achieved routes forming the recommendable route, and a used date and time of the experienced person.

4. The information processing method according to claim 3, further comprising determining, based on the achieved data group, an experienced person or people who are in a top n-th use frequency of the one or more achieved routes forming the recommendable route, where n is an integer equal to or greater than 1, and a used date and time of each experienced person, wherein
the display screen image shows the experienced person or people who are in the determined top n-th use frequency and the used date and time of each experienced person in association with the one or more achieved routes forming the recommendable route.

5. The information processing method according to claim 2, wherein the display screen image includes a map image on which the one or more achieved routes forming the recommendable route are displayed in a superimposed manner but distinctively.

6. The information processing method according to claim 2, wherein the display screen image includes a list image distinctively showing the one or more achieved routes forming the recommendable route in a list form.

7. The information processing method according to claim 1, wherein,
in the output of the one or more recommendable routes, in a case where the one or more recommendable routes include a plurality of recommendable routes, the recommendable routes are classified into a plurality of groups each including the same content, the number of recommendable routes constituting each of the groups is determined, and a recommendable route or routes of groups until a top m-th group in the determined number, where m is an integer equal to or greater than 1, are output.

8. The information processing method according to claim 1, further comprising:
acquiring selection information indicating a certain recommendable route selected by a using person from among the one or more recommendable routes; and
recording, in the acquisition of the achieved data group, an achieved route forming the certain recommendable route in the achieved data group.

9. The information processing method according to claim 1, wherein the achieved route includes a plurality of roads.

10. The information processing method according to claim 1, wherein,
in the creation of the one or more recommendable routes, the one or more recommendable routes are created by increasing the connection number one by one, and the process is finished at completion of forming the one or more recommendable routes.

11. An information processing device that creates a route, comprising:
an achieved record acquisition part that acquires an achieved data group having recordation of achieved route information associating a start point, a finish point, and an achieved route being a travel route between the start point and the finish point with one another;
a query acquisition part that acquires a query including a start point and a finish point;
a creation part that creates one or more recommendable routes each having a start point and a finish point respectively agreeing with the start point and the finish point of the query by connecting one or more achieved routes recorded in the achieved data group; and
an output part that outputs the one or more recommendable routes.

12. A non-transitory computer readable recording medium storing a program for causing a computer to serve as an information processing device that creates a route, the program causing the computer to further serve as:
an achieved record acquisition part that acquires an achieved data group having recordation of achieved route information associating a start point, a finish point, and an achieved route being a travel route between the start point and the finish point with one another;
a query acquisition part that acquires a query including a start point and a finish point;
a creation part that creates one or more recommendable routes each having a start point and a finish point respectively agreeing with the start point and the finish point of the query by connecting one or more achieved routes recorded in the achieved data group; and
an output part that outputs the one or more recommendable routes.
